(19) United States
(12) Patent Application Publication
(10) Pub. No.: US 2008/0201360 A1
(43) Pub. Date: Aug. 21, 2008

(54) Locating Persistent Objects In A Network Of Servers

(75) Inventor: Jaspal Kohli, Sunnyvale, CA (US)

Correspondence Address: BEVER HOFFMAN & HARMS, LLP;2099 Gateway Place, Suite 320, San Jose, CA, 95110, US

(73) Assignee: Mirapoint, Inc., Sunnyvale, CA (US)

(21) Appl. No.: 11/675,606

(22) Filed: Feb. 15, 2007

(51) Int. Cl. G06F 17/30

(52) U.S. Cl. 707/103 R; 707/E17.005

(57) ABSTRACT

A computer system can advantageously include a location service that minimizes changes to a directory in the event of moving a storage unit. Each storage unit can use its meta data to indicate the persistent objects the storage unit contains. The directory can store a translation between a persistent object and its corresponding storage unit. The servers can register their corresponding storage units using the location service. Based these registrations, the access network of the system can successfully request persistent objects from the appropriate servers. Advantageously, this system configuration allows a storage unit to be moved without changing a directory entry, thereby minimizing both time and system resources.

### BACKGROUND OF THE INVENTION

1. Field of Invention

This invention relates to locating persistent objects in a network of servers and routing requests to those objects.

2. Description of Related Art

In general, a persistent object can be defined as anything that is stored on a “persistent” medium, e.g. a hard drive. Generically, this persistent medium is called a storage unit herein. A server facilitates a client's request to access persistent objects in various storage units. Emails, calendaring data, files, and web pages are examples of persistent objects. In contrast, temporary objects, e.g. processes to deal with tasks and authentication information, are created by a server and stored only temporarily.

A conventional email request refers to a specific account, e.g. bobdavis@companyA.com, not to a server. This referencing provides system flexibility. Specifically, referring to FIG. 1, a client 101 requesting accessing to his email (via a proxy 108 and a company's access network 103, which is transparent to client 101) doesn't know the server name associated with his account. Typically, a company could have multiple servers, e.g. servers 104A, 104B, and 104C. Server 104A could be the only server providing email functions. However, due to load balancing, growth, failover, or reconfiguration, different and/or additional servers could also be used to provide email functions.

A computer system optimally needs flexibility in both the naming of accounts and how accounts are placed within the system. Thus, giving out the server name or server address to client 101 could limit system flexibility. To preserve this flexibility, a directory 102 controlling access to the servers is typically used. Proxy 108 can perform the task of routing the request from client 101 to the correct email server (e.g. server 104A) using directory 102 and a location service 109.

Specifically, a “mailhost” attribute can be used for locating the email server for a particular user. This mailhost attribute allows the email account name to be translated into a server address. For example, an email request access to the email account bobdavis@companyA.com can be directed as a location query 110 to directory 102. The mail host attribute for client Bob Davis is stored in directory 102. Directory 102 provides the translation to the appropriate server name and address, e.g. to server 104A in FIG. 1.

Of importance, the real location of email for Bob Davis resides in storage unit 105A. The purpose of server 104A is to manage the data contained in storage unit 105A for read/write accesses to any mailboxes contained therein, e.g. read the requested mailbox from storage unit 105A and put the requested mailbox on access network 103 (which is then transferred to client 101 via proxy 108. As indicated in FIG. 1, servers 104A-104C perform this access function for storage units 105A-105C, respectively.

However, if storage unit 105A was instead accessed by server 104B, then the name and address of server 104B has implicitly changed. Thus, in this system configuration, the location bindings directly refer to the access facilitating servers.

Notably, any changes to the server configuration (i.e. storage units being moved) are performed through location updates 111, which are provided to location service 109. Typically, a system administrator performs these location updates 111 manually. Changing the access of a mailbox for one user to a different server and updating the translation information in directory 102 is easy. However, the task of changing the access of hundreds or even thousands of mailboxes to one or more different servers, and then updating the translation information in directory 102 can be extremely time consuming for a system administrator and waste considerable system resources.

Therefore, a need arises for a more time and system efficient method of locating persistent objects, like email, using a network of servers.

### SUMMARY OF THE INVENTION

A computer system can advantageously include a location service that minimizes changes to a directory when storage units are moved. Each storage unit can use its meta data to indicate the persistent objects the storage unit contains. For this reason, the storage units can be characterized as being “self-describing”. In one embodiment, the storage units are virtual storage units forming network storage. The directory can advantageously store a translation between each persistent object and its corresponding storage unit.

The location service allows the servers to register their corresponding storage units. In one embodiment, the servers are virtual servers forming a network server. Based on registrations stored by the location service, the access network of the system can successfully request persistent objects from the appropriate servers. Advantageously, this system configuration allows a storage unit to be moved (i.e. accessible by another server) without changing a directory entry, thereby minimizing both time and system resources.

A method of dealing with persistent objects accessible by a network of servers is described. In this method, the locations of the persistent objects can be bound to the storage units in which they are contained. Each server is allowed to register its corresponding storage unit. Routing requests to the persistent objects can include determining the storage unit that contains the persistent object and then determining the server having access to that storage unit. Access to a storage unit can be re-registered with a backup server after the failure of a server currently registered to access that storage unit.

A method of translating in a computer system is also described. In this method, meta data in each storage unit can be provided. This meta data can describe persistent objects contained by the storage unit. A directory can be used to translate a persistent object to the storage unit. A location service can then be used to translate that storage unit to a server accessing the persistent object. Persistent objects include but are not limited to email, calendaring data, and to other applications.

### BRIEF DESCRIPTION OF THE FIGURES

FIG. 1 illustrates a conventional system that binds the location of persistent objects to the server(s) that access those persistent objects. Unfortunately, in this system, any changes to server configurations require changing the system directory.

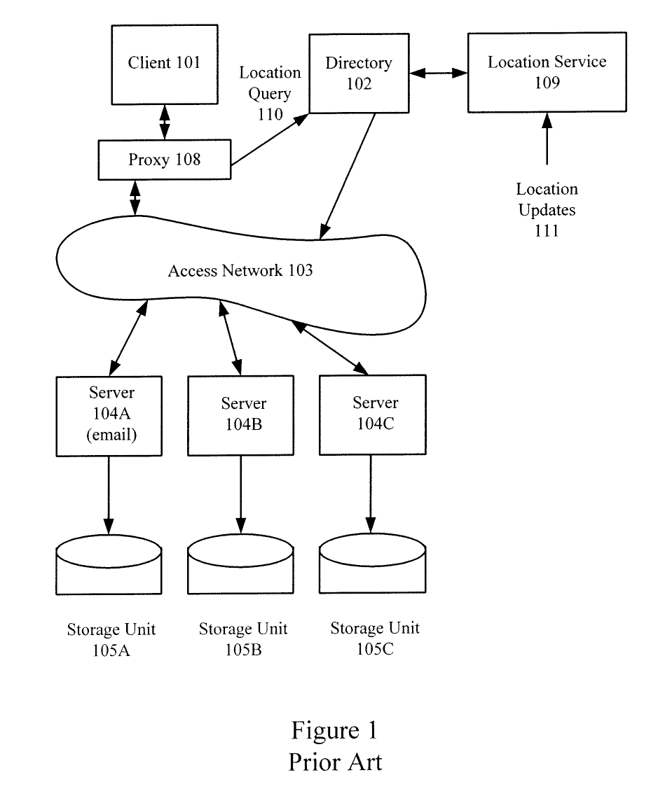

FIG. 2 illustrates a system that binds the location of persistent objects to the storage units in which they are contained. Each unit of storage is self-describing, i.e. indicates the persistent objects therein. In this system, changes to server configurations require no changes to the system directory.

FIG. 3 illustrates the system of FIG. 2 including a plurality of virtual drives comprising network storage.

FIG. 4 illustrates the system of FIG. 2 including a plurality of virtual servers comprising a network server.

FIG. 5 illustrates a system providing a backup server programmed to activate itself in the event of the failure of an active server. In this system, the backup server then registers with the location service.

### DETAILED DESCRIPTION OF THE FIGURES

To ensure a time efficient method of locating persistent objects, the location of the persistent object is bound to its storage unit, not to the server that accesses the storage unit. A location service, described below, can advantageously receive location updates directly from the servers. These location updates can be both dynamic and automatic, thereby accelerating the update process without need to update an actual directory entry.

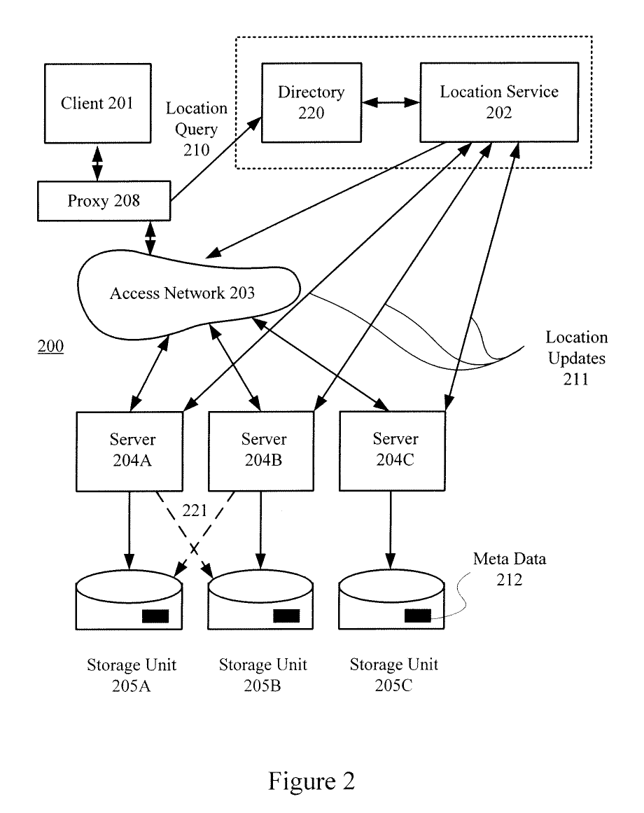

FIG. 2 illustrates an exemplary computer system 200 including a server network 204, which comprises servers 204A, 204B, and 204C. In system 200, servers 204A, 204B, and 204C facilitate requests from a client 201 to access persistent objects in storage units 205A, 205B, and 205C. A proxy 208 can perform the task of routing the client's requests to the correct server (via access network 203) using a directory 220 and a location service 202.

In system 200, servers 204A-204C can advantageously directly provide any location updates 211 to location service 202. For example, during an initial registration process, servers 205A-205C could indicate their respective storage units 205A-205C with location service 202.

Notably, system 200 retains a two-level translation from an email account to the location of the email account in the storage unit. For example, an entry in a directory 220 could indicate that Bob Davis' mailbox is, for example, in storage unit 205A, thereby providing a first translation. Location service 202 can then provide a second translation from the identified storage unit to its current server.

Location updates 211 can also be generated dynamically for any server configuration changes in system 200. For example, if servers 204A and 204B are moved to facilitate access to storage units 205B and 205A, as indicated by dashed arrows 221, then server 204A would register its new storage unit 205B with location service 202. Similarly, server 204B would register its new storage unit 205A with location service 202. Advantageously, the entries in directory 220 can remain the same, i.e. nothing needs to be changed because the binding of the locations of the persistent objects to their storage units remains the same.

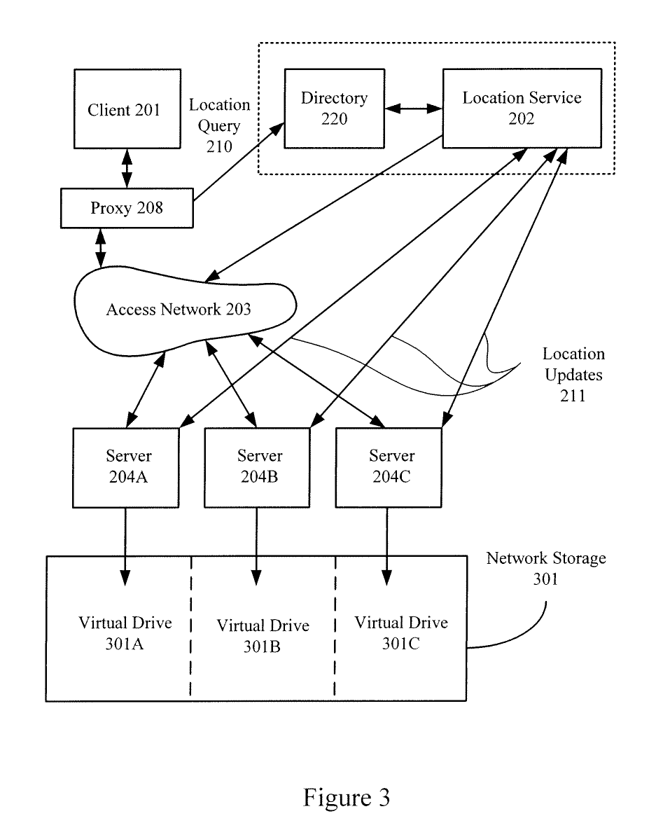

Note that a storage unit is generally thought of as a physical structure, but could also be a “logical” or a “virtual” storage unit. Therefore, in one embodiment shown in FIG. 3, servers 204A-204C can facilitate access to virtual drives 301A-301C, wherein virtual drives 301A-301C can comprise network storage 301. Because virtual drives are software managed, one or more of virtual drives 301A-301C can easily be reconfigured to include new or different persistent objects.

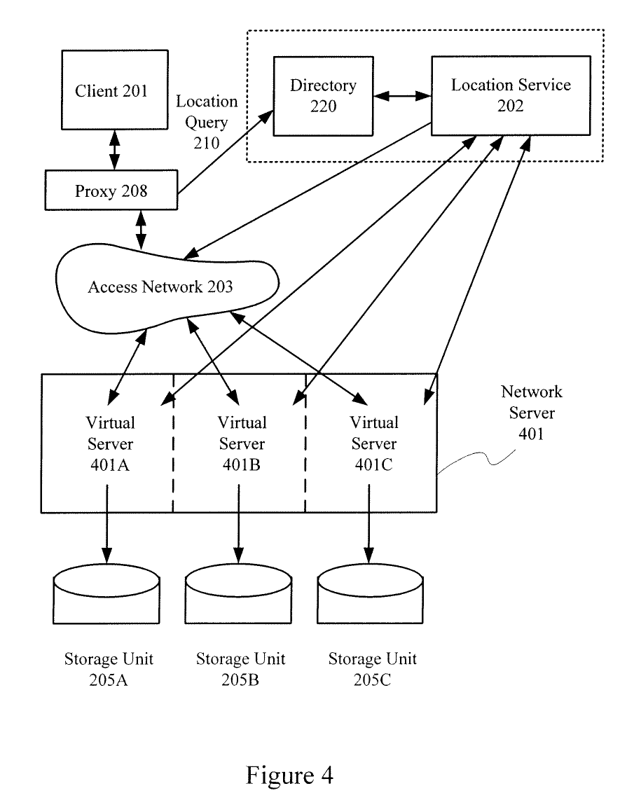

Similarly, a server is also generally thought of as a physical structure, but could also be a virtual server. Therefore, in one embodiment shown in FIG. 4, virtual servers 401A-401C can facilitate access to storage units 205A-205C, wherein virtual servers 401A-401C can comprise a network server 401. Note that virtual servers 401A-401C, just like physical servers, can register their corresponding storage units 205A-205C with location service 202, thereby still allowing all requests to be routed dynamically to the appropriate servers without changing directory 220.

Note that a virtual server can be scaled to the needs/limitations of the storage unit. Similarly, a virtual drive can be scaled to the needs/limitations of the virtual server. In one embodiment, both virtual servers and virtual drives can be used to maximize system flexibility.

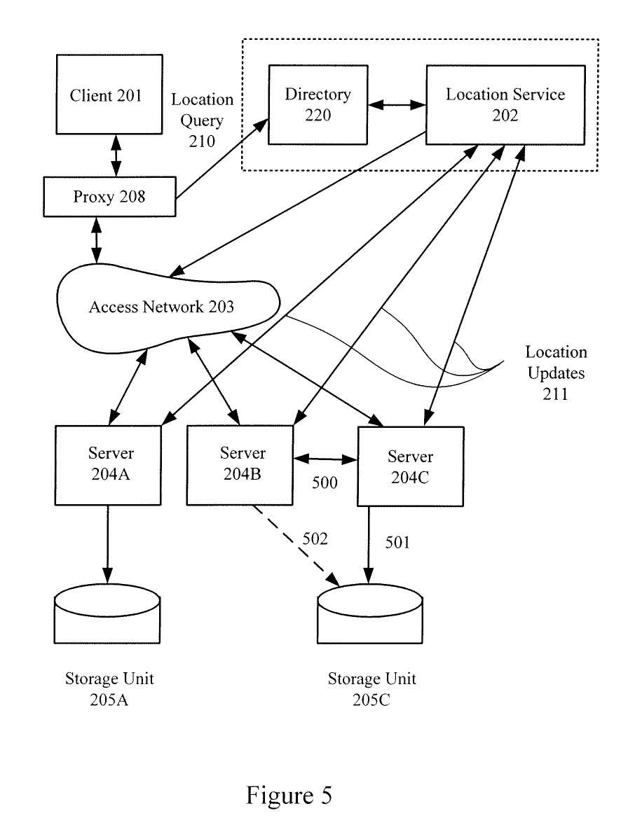

FIG. 5 illustrates an embodiment in which two servers 204B and 204C could have access to the same storage unit 205C in case of failure. In this embodiment, at any point in time, only one of servers 204B and 204C, i.e. either the “active” server or the “backup” server, accesses storage unit 205C. For example, server 204C could be initially registered with location service 202 as providing access to storage unit 205C. However, in the case of a failure of server 204C, then server 204B can be programmed to note this failure (see arrow 500), wake up, register with location service 202, and route any request from client 201 (via proxy 208 and access network 203) to storage unit 205C.

Referring back to FIG. 2, storage units 205A-205B can be characterized as “self-describing”. Specifically, each storage unit 205 can have appropriate meta data 212 (e.g. in the email context, the mailboxes stored in the storage unit) in a defined location. In this manner, meta data 212 can be used by servers 204A-204C during registration. In one embodiment, meta data 212 can be used to generate directory 220. In another embodiment, meta data 212 can be used to confirm information in directory 220 before the request is forwarded to the appropriate server (and thus storage unit). In yet another embodiment, when persistent objects are changed in a storage unit, then the corresponding server can be notified to perform a re-registration with location service 202 (and updating directory 220, if not performed by a system administrator).

In summary, the self-describing storage units and the location service advantageously enable a computer system to move storage units quickly and automatically. For example, in load balancing, a storage unit can easily be shifted from an over-burdened server to a less-burdened server. This shifting requires no change to the directory, merely a registration to the location service. Moreover, as described in reference to FIG. 5, one server can be programmed to act as the backup for an active server. In the case of failure, the back-up server can easily register the storage unit previously registered by the active server, once again not changing the directory. In yet another embodiment, during disaster recovery, a remote storage unit that includes identical persistent objects to a local storage unit can be activated to register with the location service and facilitate requests instead of a crashed server.

Although illustrative embodiments of the invention have been described in detail herein with reference to the accompanying figures, it is to be understood that the invention is not limited to those precise embodiments. They are not intended to be exhaustive or to limit the invention to the precise forms disclosed. As such, many modifications and variations will be apparent.

For example, note that the directory and the location service can be formed separately or together. Therefore, the directory and the location server are conceptually distinct, but could be enabled in various hardware/software configurations. Accordingly, it is intended that the scope of the invention be defined by the following Claims and their equivalents.

1. A method of dealing with persistent objects accessible by a network of servers, the method comprising:
binding the locations of the persistent objects to the storage units in which the persistent objects are contained;
allowing each server in the network of servers to register its corresponding storage unit; and
routing requests for the persistent objects by:
determining the storage unit that contains the persistent object; and
determining the server having access to that storage unit.

2. The method of claim 1, further including re-registering access to a storage unit with a backup server after failure of a server currently registered to access that storage unit.

3. A method of forming a directory and a location service, the method comprising:
in the directory, binding a location of a persistent object to a storage unit in which the persistent object is contained; and
in the location service, providing a translation of the storage unit to a current server having access to that storage unit.

4. A location service for a network of servers, the location service comprising:
means for allowing a server to automatically register itself as accessing a particular storage unit.

5. The location service of claim 4, further including means for allowing a backup server to re-register access to a storage unit after failure of a server currently registered to access that storage unit.

6. A location service comprising:
a listing of registered servers providing access to corresponding, self-describing storage units.

7. The location service of claim 6, wherein at least one registered server is indicated as being replaced by a backup server, the location service further comprising instructions that allow the backup server to re-register access to a storage unit after failure of a server currently registered to access that storage unit.

8. A system comprising:
a plurality of storage units, each storage unit including meta data indicating any persistent objects the storage unit contains;
a plurality of servers, each server facilitating access to a storage unit by using the meta data of that storage unit.

9. The system of claim 8, further including:
a directory for storing a storage unit location of a persistent object; and
a location service that allows the plurality of servers to register their corresponding storage units, thereby allowing access to the persistent object without updating the directory.

10. The system of claim 9, further including:
an access network for requesting a persistent object from an appropriate server based on a registration stored by the location service.

11. The system of claim 8, wherein the plurality of storage units form a network storage.

12. The system of claim 8, wherein the plurality of servers form a network server.

13. A lookup for a persistent object, the lookup comprising:
determining a storage unit that contains the persistent object; and
after determining the storage unit, determining a server that accesses the storage unit.

14. A method of translating in a computer system, the method comprising:
providing meta data in each storage unit, the meta data describing persistent objects contained by the storage unit;
using a directory to translate a persistent object to the storage unit; and
using a location service to translate that storage unit to a server accessing the persistent object.

15. A method of accessing a storage unit in a system, the method comprising:
registering a server that accesses the storage unit without changing a directory entry; and
accessing the storage unit based on the registering.
